(19) United States
(12) Patent Application Publication
(10) Pub. No.: US 2022/0285901 A1
(43) Pub. Date: Sep. 8, 2022

(54) BUNDLED CABLE INSTALLATION SYSTEMS AND METHODS

(71) Applicant: CORNING RESEARCH & DEVELOPMENT CORPORATION, Corning, NY (US)

(72) Inventors: Michael Todd Faulkner, Granite Falls, NC (US); Lars Kristian Nielsen, Denver, NC (US); Marcus Ray Sullivan, Hickory, NC (US)

(21) Appl. No.: 17/688,855

(22) Filed: Mar. 7, 2022

Related U.S. Application Data
(63) Continuation of application No. 63/157,233, filed on Mar. 5, 2021.

(51) Int. Cl. H01R 43/28; H02G 3/30

(52) U.S. Cl. CPC H01R 43/28; H02G 3/30

(57) ABSTRACT

A method of delivering cables for a data center comprises: collecting information for different cables needed in a room of the data center, wherein the information includes cable type, length, and intended location data; determining groups of the different cables for bundling together at the data center based on the information; and for at least one of the groups, supplying the different cables for the group together as a common unit.

### PRIORITY APPLICATION

This application claims the benefit of priority of U.S. Provisional Application No. 63/157,233, filed on Mar. 5, 2021, the content of which is relied upon and incorporated herein by reference in its entirety.

### BACKGROUND

The present disclosure relates to bundling different cables to facilitate installation. The bundling may occur in the factory where the cables are produced, in the field on sites where the cables are used, or some combination of the two. Various packaging concepts and installation techniques related to the bundling are also disclosed.

The ever-increasing demand for data has resulted in the development of large, scalable data centers to store and process this data. Some modern data centers are referred to as “hyperscale” data centers due to their size and scalability. For example, a typical hyperscale data center includes several thousand servers housed within multiple data halls, which are large areas (e.g., 10,000+ square feet) containing many rows of many equipment racks. The large number of equipment racks are needed to not only support the servers, but also other networking equipment that forms part of a communication network for the data center. The thousands of servers are all interconnected to each other in the network.

In particular, the servers are interconnected through multiple layers of switches. Many hyperscale data centers have networks based on a spine-leaf architecture, where a spine layer of switches serves as network backbone and routes signals between a leaf layer of “fabric switches” (“leaf switches”). Every fabric switch is interconnected with every spine switch in a full mesh topology, and each fabric switch provides access to the servers. This access is typically through another link layer, with the fabric switches being connected to rack switches, which in turn connect to the servers as end points in the network. The rack switch associated with a given server may be on the same equipment rack as that server, and sometimes be referred to as a “top-of-rack” switch. The switch-to-switch links (spine-to-leaf and leaf-to-rack), and in some cases the switch-to-server links, are typically achieved by optical fiber cables and passive optical equipment (e.g., distribution boxes, cabinets/enclosures, or the like). Optical fibers provide very high bandwidths with lower signal loss compared to traditional data transmission mediums (e.g., copper wires).

Due to the extremely large number of optical fiber links in a hyperscale data center, the cabling infrastructure can be complex. Many different optical fiber cables of many different lengths are needed to connect the different pieces of equipment. The routing and placement of such a large variety and number of cables presents many challenges. For example, oftentimes it is necessary to pull or push cables of different lengths from a main distribution frame (MDF) area/room of a data center to different intermediate distribution frames (IDFs) in a data hall. An installer may have a “pull schedule” that lists the different cables needed for this purpose, including information about the cable type (e.g., number of fibers, length) and the intended locations for the cables (e.g., the row number, equipment rack number, and particular IDF to which a cable is intended to connect). The cables must typically be routed through openings in walls (“firewalls”) and along trays or raceways that eventually support the cables above the rows of equipment racks. Accordingly, the pull schedule may also include information about the intended tray for a given cable, as there may be multiple levels of cable trays above the rows of equipment racks.

Working from the pull schedule, an installer must first locate the different cables in storage or receiving areas of the data center. The cables are typically packaged individually, with many cables being shipped to the data center on their own reel. Locating the different reels or other packages for the different cables and moving them to the IDF can take a considerable amount of time. At some point the installer must also take the time to label the different cables according to the pull schedule so it is known where to route the cables. This is typically done manually, writing information onto labels and applying them to the cables, or writing on the cables themselves. Once at the IDF and labelled, a cable on the pull schedule can be pulled or otherwise routed to its intended location according to its label. For this step it may also be necessary to apply an additional label to a pulling grip (also referred to as a “pulling sock”) placed on an end of the cable for the routing operation, as the pulling grip may cover the previously-applied label on the cable that includes information about the intended location. The routing may also be done in an opposite manner, beginning at an IDF and routing the cable back to the MDF. The empty reels or other packages are disposed of once completing the cable routing.

Routing each cable to its intended location can be time-consuming and challenging itself, but the situation is further complicated by the need to organize the cables in the cable trays in case a given cable needs to be easily removed (e.g., for replacement or repair) at a later date. A significant amount of the overall installation time for a data center's network cabling infrastructure is associated with post-routing organization of the cables, which is sometimes referred to as “grooming,” “dressing,” or “combing.”

The result of the above-mentioned complexities and challenges is that installing the cabling infrastructure in a data center can be very time-consuming. The labor time also comes with an expensive.

### SUMMARY

Various methods of delivering cables for a data center are disclosed. According to one embodiment, such a method comprises collecting information for different cables needed in a room of the data center. The information includes cable type, length, and intended location data. The method also comprises: determining groups of the different cables for bundling together at the data center based on the information; and, for at least one of the groups, supplying the different cables for the group together as a common unit.

Additional features and advantages will be set out in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic view of one example of data hall layout for a data center.

FIG. 2 is an image of a sample fire-rated wall having pathway devices with openings to allow cable to pass through the wall.

FIG. 3 is a schematic diagram of an example concept for supplying and bundling multiple cables together to be pulled/routed together.

FIG. 4 is a schematic diagram illustrating one variant of the example of FIG. 3.

FIG. 4A is an image of an example device that may be used to pull a bundled assembly of cables.

FIG. 5 is a schematic diagram illustrating another variant of the example of FIG. 3.

FIG. 6 is a schematic perspective view of a clip for a bundled group of cables.

### DETAILED DESCRIPTION

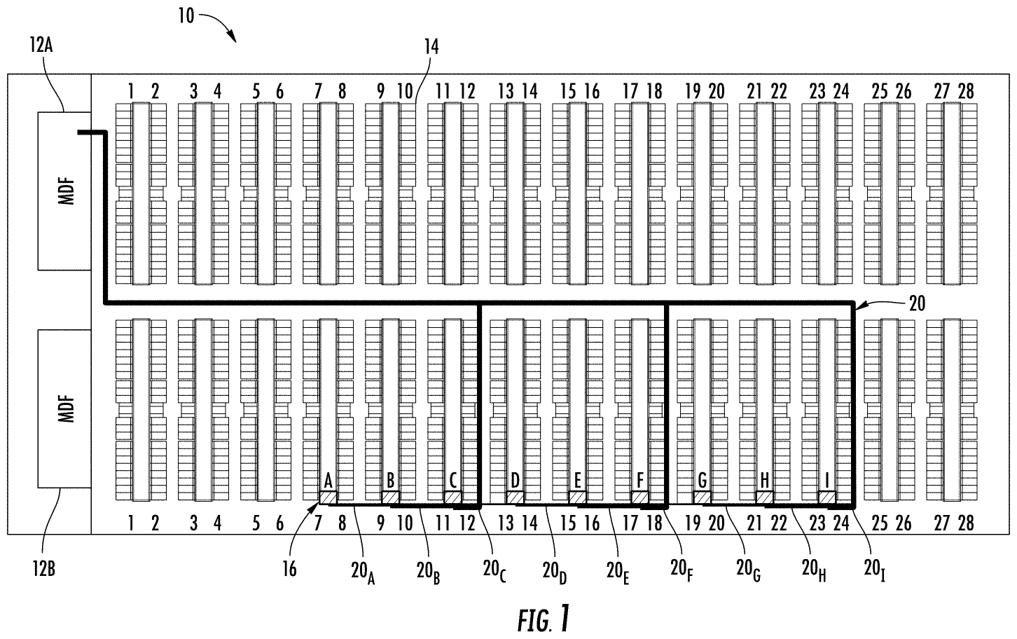

One example data hall 10 for a data center is shown in FIG. 1 to provide context for this disclosure. An example routing of cables will also be described in connection with FIG. 1. It will be appreciated, however, that the concepts of this disclosure may apply to a wide variety of data center layouts and cabling infrastructure designs.

The data hall 10 includes two main distribution frame (MDF) areas 12A, 12B, each of which may include several switches that form part of a network fabric for the data center. The switches may be, for example, leaf switches in a spine-leaf architecture. The switches may be located on equipment racks, and potentially within cabinets/enclosures, in the MDF areas 12A, 12B. The data hall 10 also includes many rows of equipment racks 14, many of which may be used to support intermediate distribution frame (IDF) equipment 16 and servers.

In general, and as discussed in the background section above, equipment in the MDF areas 12A, 12B may be connected to the IDF equipment 16 using optical fiber cables. Different lengths of cables are required due to the different locations of the IDF equipment 16. FIG. 1 includes an overlay that schematically represents the routing of different trunk cables 20_{A-I} from MDF area 12A to IDF equipment 16_{A-I}. A different trunk cable 20 may extend to each piece of IDF equipment 16, but the routing path for the different trunk cables 20 may overlap (be the same) for substantial lengths. For example, trunk cables 20_{A-C} are shown as having the same routing path from the MDF area 12A to a far end of rows 11 and 12, where the IDF equipment 16_{C} for trunk cable 20_{C} is generally located. At this point the trunk cable 20_{C} “drops” off and routes to the IDF equipment 16_{C}. The trunk cables 20_{A}, 20_{B} continue down a shared routing patch to a location adjacent the ends of rows 9 and 10, where the IDF equipment 16_{B} for trunk cable 20_{B} is generally located. At this point the trunk cable 20_{B} “drops” off and routes to the IDF equipment 16_{B}. The trunk cable 20_{A} then continues along a routing path to a location adjacent the ends of rows 7 and 8, where the IDF equipment 16_{A} for trunk cable 20_{A} is generally located.

Trunk cables 20_{A-C} can be considered a first grouping of trunk cables 20 that share a common routing path to the first drop-off point at the far end of rows 11 and 12. FIG. 1 also illustrates trunk cables 20_{D-F} as a second grouping of trunk cables 20, and trunk cables 20_{G-I} as a third grouping of trunk cables 20. The second and third grouping of trunk cables 20 are routed in a manner similar to the first grouping of trunk cables 20, but to the ends of different rows that correspond to the location of different IDF equipment 16. As shown in FIG. 1, the routing paths for the first, second, and third grouping of trunk cables 20 also overlap for at least some length, with the first grouping (trunk cables 20_{A-C}) dropping off first at row 12, the second grouping (trunk cables 20_{D-F}) dropping off next at row 18, and the third grouping (trunk cables 20_{G-I}) then continuing independently along its respective routing path.

Rather than locating, labeling, and routing each of the trunk cables 20 independently at the site of the data center, the present disclosure provides various techniques for bundling at least some of the trunk cables 20 together to reduce the number of cable routing operations, facilitate organization during and after installation, and potentially reduce packaging. Various bundling steps may be performed by the manufacturer/supplier of the cables 20 in some embodiments so that the cables 20 can be delivered to the data center in the bundled arrangement. Embodiments are also possible where some bundling steps are performed by the supplier of the cables 20 and remaining bundling steps are performed by installers at the data center, still resulting in a bundled arrangement to facilitate routing the cables 20 during installation of the cables 20.

As an example, with reference to FIG. 1, the trunk cables 20 of a given grouping may be bundled together (e.g., the first grouping of trunk cables 20_{A-C} being bundled together, the second grouping of trunk cables 20_{D-F} being bundled together, and the third grouping of trunk cables 20_{G-I} being bundled together). The different groupings of trunk cables 20 may also be bundled together in some embodiments (e.g., the first, second, and/or third groupings of the trunk cables 20 being bundled together).

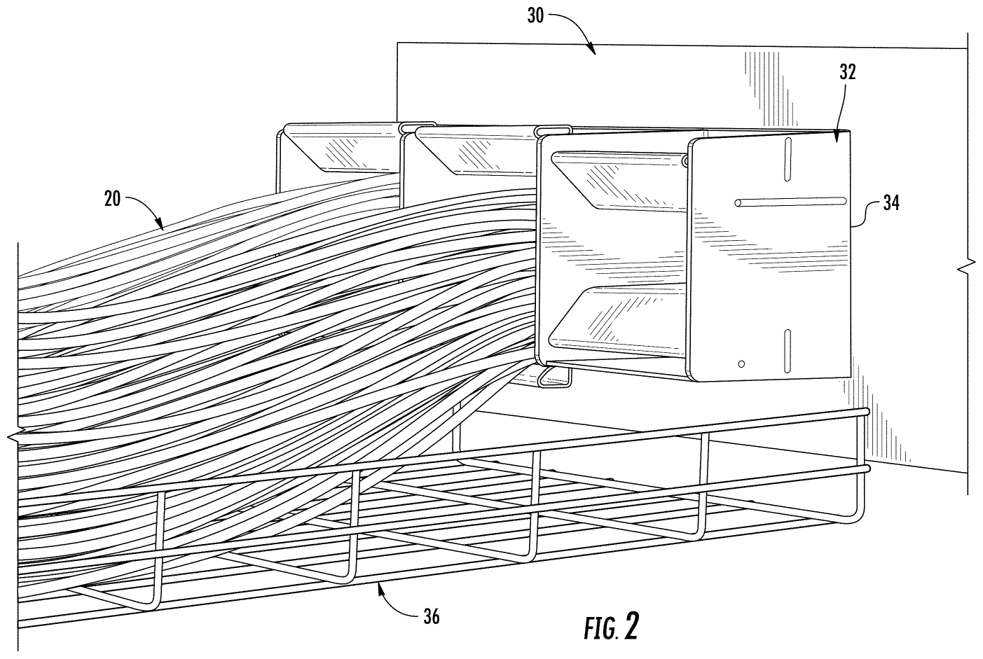

The determination of which trunk cables 20 to bundle together may depend on the location of the IDF equipment 16, available routing paths (e.g., in cable trays) to such equipment, and limitations along the routing paths. For example, the MDF areas 12A, 12B are typically enclosed rooms separated from the portion of the data hall 10 that contains the rows by fire-rated walls 30 (“firewalls 30”). The trunk cables 20 must route though available openings in these firewalls 30. To this end, FIG. 2 illustrates one example of a portion of a firewall 30 with various pathway devices 32 occupying openings 34 in the firewall 30. The pathway devices 32 allow cables 20 to pass through the firewall 30 and may be located adjacent cable trays 36 that form part of the routing paths. As can be appreciated, the size of cables 20 to be routed (largely driven by the fiber count for such cables 20) and the size of the pathway devices 32 may limit the number of cables 20 that may be bundled together for routing between the MDF areas 12A, 12B and the IDF equipment 16.

According to one aspect of this disclosure, information is collected by a cable supplier regarding the different cables needed for a data hall (or other room in a data center). The information may include the cable type (number and grouping of optical fibers, connector types, etc.), cable length, and intend location data. For example, the intended location data may include an identification of the equipment to which ends of a given cable is intended to connect (e.g., IDF equipment 16_{A-I}), the location of that equipment (e.g., row number in the data hall 10, equipment rack number in the relevant row, rack unit/shelf within a given equipment rack, etc.), and even cable tray or other cable routing path information. The cable supplier may also gather information about the data center itself, such as the layout of rooms, the firewalls 30 separating rooms, and the size and number of openings 34 in pathway devices 32 through the firewalls 30.

Using the information that is collected, the cable supplier may determine groups of the different cables 20 that may be bundled together for a common pulling operation. Alternatively, the data center owner/builder may make this determination and provide information about the desired bundling to the cable supplier. The cable supplier can then use this information in different ways to facilitate the bundling and pulling operations.

For example, the cable suppler may label the requested cables 20 with the at least some of the intended location data before sending the cables 20 to the data center. This could be done where the cables 20 are manufactured or stored prior to shipping to the site of intended use. Any suitable labeling technique may be used, such as printing directly on cable jackets or applying separate labels to cables 20 by adhesive or other fastening techniques. One or both ends of a given cable 20 may be labeled with information about the equipment and/or location for the end of the cable 20. As mentioned in the background section above, oftentimes this labeling is done manually by an installer at the data center.

The cable supplier may also package and supply the cables 20 of each grouping together as a common unit. As used in this disclosure, the term “common unit” refers to multiple cables being packaged or otherwise arranged together so that there is not a need to separately locate individual packages of the cables at the data center. One example of a common unit is shown in FIG. 3, which illustrates a reel 40 that includes dividers/flanges 42 to divide the reel 40 into different sections. Each section of the reel 40 is used for a different one of the cables 20 of a given grouping. Thus, FIG. 3 illustrates a common unit (the reel 40) divided into four sections for storing four different cables 20. At least two of the cables 20 are different lengths due to being intended for connection to two different locations in the data center. The reel 40 may be designed so that each divided section can spin/rotate freely relative to adjacent section(s). Such an arrangement allows for individual payoff/payout of the different cables 20. Stated another way, the reel is configured so that the each of the divided sections can payout the associated cable independently of the other sections. In alternative embodiments not shown, each cable 20 for the grouping may be provided on a respective reel that may be combined directly or indirectly with the reels for the other cables 20 of the grouping. The different cables 20 are still supplied as a common unit in such embodiment, possibly on a common palette or other frame, and possibly having a single SKU representing the grouping to be bundled. The common unit may still be configured to allow independent payout of the different cables 20.

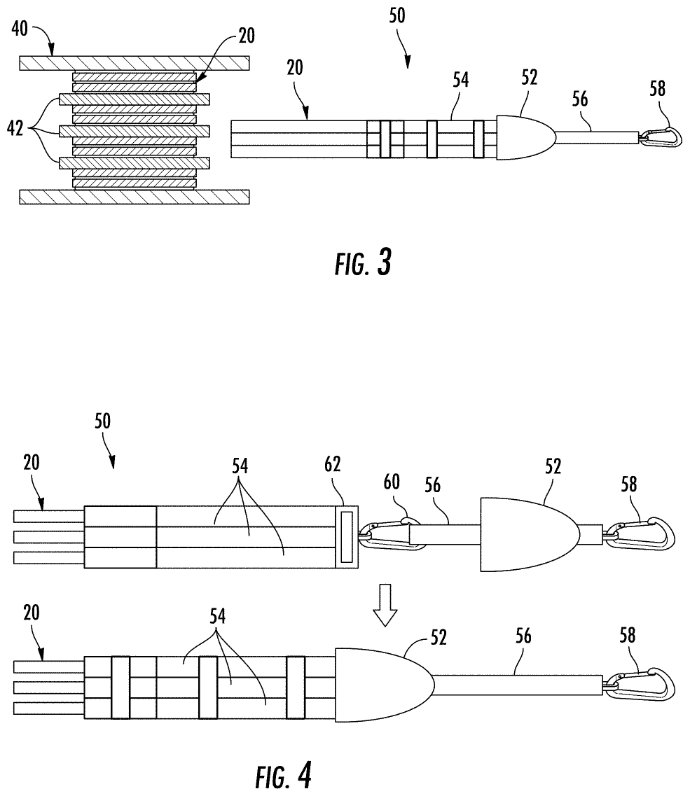

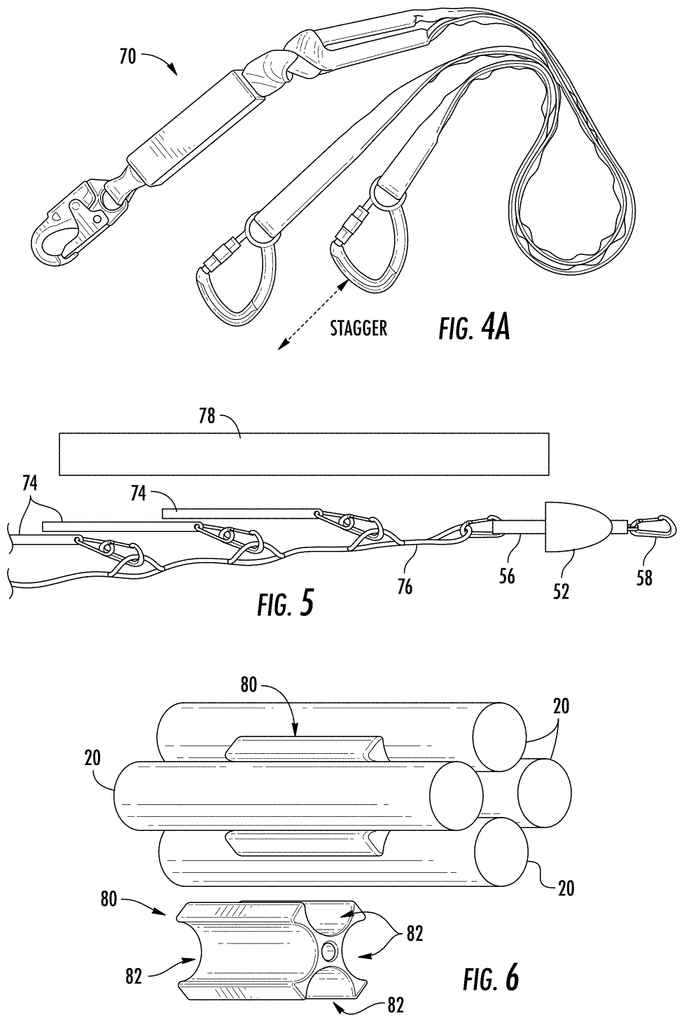

Once the common unit is at the data center and in an appropriate location, the different cables 20 may be paid out from the common unit and bundled together as a bundled assembly 50 for a common pulling operation, as schematically illustrated on the right in FIG. 3. The bundled assembly 50 may include a nose cap/cone 52 and mesh material or other cover (not shown) over ends of the different cables 20, which may each be connected to a common pulling strap 56. More specifically, each of the different cables may include a respective pulling grip 54 on an end section of the cable 20. The pulling grips may be secured together using tape, hook-and-loop fasteners, or the like, as schematically shown. FIG. 3 illustrates the common pulling strap 56 extending through the nose cap 52 and terminating with a carabiner 58, but other forms of pulling eyes may be used in alternative embodiments. The manner in which the different cables 20 are connected to a common pulling strap 56 may vary. FIGS. 4 and 5 illustrate two different examples.

As shown in FIG. 4, the common strap 56 may include a rear carabiner 60 or other loop at a rearward end to which the different cables 20 are attached. Although not shown, each pulling grip 54 may include a respective pulling eye attached to the rear carabiner 60. FIG. 4 schematically illustrates a box 62 to represent the attachment location between the pulling grips 54 and the rear carabiner 60. Different methods for attaching the cables 20 will be appreciated by persons skilled in cable installation. It may be advantageous to attach some of the pulling eyes of the pulling grips 54 indirectly, using intermediate straps of different lengths for different cables 20 to achieve a staggered arrangement. This general principle may be applied in some embodiments using a device 70 like what is shown in FIG. 4A.

FIG. 5 illustrates an alternative for a bundled assembly where respective pulling grips 74 for three different cables are connected to different attachment points provided along the length of a common tether/lanyard 76, which in turn is attached to the common strap 56. A mesh material 78 is schematically illustrated above the common tether 76 to illustrate that this end of the bundled arrangement may be covered with the mesh material 78 or a similar cover to prevent snagging during a pulling operation.

In some embodiments, the components for the bundled assembly 50 may be provided as part of the common unit. The cable supplier may even label at least one of the components with at least some of the intended location data for the different cables. For example, the nose cap 52, common strap 56, and/or cover for the bundled assembly (e.g., mesh material 78) may be labeled with information about the equipment and/or location for at least one of the cables in the bundled assembly.

As mentioned above, the common unit (e.g., reel) on which the cables 20 are supplied may allow for individual payoff/payout of the different cables 20. Such individual payout may allow the staggering of the cables 20 in the bundled assembly 50 to be achieved more effectively.

To assist with organization during the pulling operation and afterwards when portions of the cables 20 are stored in cable trays (e.g., cable tray 36; FIG. 2), one or more clips may be applied during the bundling process. FIG. 6 illustrates one example of a clip 80 that includes four peripheral sections 82 for receiving four respective cables 20 (FIG. 1). Although only a short clip 80 is shown, in some embodiments the clip 80 may run along substantial portions of the length (or even the entire length) of a bundled assembly. Alternatively, many clips 80 may be used at many different spaced apart locations along the length of a bundled assembly. The clip(s) 80 may be applied as the cables 20 are paid out from reels (or sections of a common reel) and brought into the bundled formation.

The clip 80 in FIG. 6 is designed for positioning in the middle of four cables 20 (which form a bundled assembly). This may help avoid the clip 80 from snagging on cable trays or the like during the pulling operation. The clip 80 is also designed so that the cables 20 can be snapped into and out of the peripheral sections 82 of the clip 80. Thus, cables 20 can be removed from the bundled assembly if needed, such as during decommissioning of one or more of the cables 20 of the group.

While the present disclosure includes the description of certain embodiments, the claims that follow are not limited to details of such embodiments unless those details are recited in the claims. Many modifications and variations of various features associated with specific embodiments of this disclosure will be readily apparent to skilled persons. Additionally, the various features discussed in connection with one specific embodiment may be combined with features from other embodiments shown, described, or appreciated based on this disclosure.

What is claimed is:

1. A method of delivering cables for a data center, comprising:
collecting information for different cables needed in a room of the data center, wherein the information includes cable type, length, and intended location data;
determining groups of the different cables for bundling together based on the information collected for the different cables; and
for at least one of the groups, supplying the different cables for the group together as a common unit.

2. The method of claim 1, wherein the data center includes rooms that have rows of equipment racks, and wherein the intended location data for each of the different cables in the collecting step comprises information about the room, the row, or the equipment rack associated with an end of the cable.

3. The method of claim 1, further comprising:
collecting cable routing information for the different cables, wherein the cable routing information includes walls in the data center crossed by routing paths for the different cables and pathway devices in the walls that allow the cables to pass through the walls, wherein the collected cable routing information is also used to determine the groups of the different cables for bundling together.

4. The method of claim 1, further comprising:
labeling at least one end of each of the different cables with at least some of the intended location data, wherein the labeling is performed before supplying the different cables for each group together as a common unit.

5. The method of claim 1, wherein the common unit for at least one of the groups comprises a reel having multiple sections that each store a respective cable of the different cables in the group, and wherein the reel is configured so that the each section of the multiple sections can payout the respective cable independently of the other sections.

6. The method of claim 1, further comprising:
bundling the different cables associated with the common unit together to form a bundled assembly.

7. The method of claim 6, wherein the bundling is performed before supplying the different cables for the group together as a common unit.

8. The method of claim 6, wherein the bundling is performed after supplying the different cables for the group together as a common unit.

9. The method of claim 8, further comprising:
locating the common unit in a first room of the data center, wherein the bundling step is performed in the first room; and
pulling the bundled assembly to a different room of the data center.

10. The method of claim 6, wherein the bundling step comprises connecting ends of the different cables to a common pulling strap.

11. The method of claim 6, wherein the bundled assembly includes ends of the different cables staggered relative to each other.

12. The method of claim 1, further comprising:
for at least one of the groups, securing the different cables of the group together using at least one clip.

13. A method of delivering cables for a data center, comprising:
collecting information for different cables needed in a room of the data center, wherein the information includes cable type, length, and intended location data;
determining groups of the different cables for bundling together based on the information collected for the different cables; and
for at least one of the groups:
supplying the different cables for the group together as a common unit; and
bundling the different cables associated with the common unit together to form a bundled assembly; and
labeling at least one end of the bundled assembly with at least some of the collected information for the different cables.

14. The method of claim 13, wherein the data center includes rooms that have rows of equipment racks, and wherein the intended location data for each of the different cables in the collecting step comprises information about the room, the row, or the equipment rack associated with an end of the cable.

15. The method of claim 13, further comprising:
collecting cable routing information for the different cables, wherein the cable routing information includes walls in the data center crossed by routing paths for the different cables and pathway devices in the walls that allow the cables to pass through the walls, wherein the collected cable routing information is also used to determine the groups of the different cables for bundling together.

16. The method of claim 13, further comprising:
labeling at least one end of each of the different cables with at least some of the intended location data, wherein the labeling is performed before supplying the different cables for each group together as a common unit.

17. The method of claim 13, further comprising:
securing the different cables of the bundled assembly together using at least one clip.

18. The method of claim 17, wherein the at least one clip includes peripheral sections each receiving one of the different cables, and wherein the peripheral sections are circumferentially distributed so that the clip is positioned in a middle of the bundled assembly.
